(19) United States
(12) Patent Application Publication
(10) Pub. No.: US 2021/0042664 A1
(43) Pub. Date: Feb. 11, 2021

(54) MODEL TRAINING AND SERVICE RECOMMENDATION

(71) Applicant: BEIJING SANKUAI ONLINE TECHNOLOGY CO., LTD, Beijing (CN)

(72) Inventor: Ziwei WANG, Beijing (CN)

(21) Appl. No.: 17/077,416

(22) Filed: Oct. 22, 2020

Related U.S. Application Data
(63) Continuation of application No. PCT/CN2018/121950, filed on Dec. 19, 2018.

(30) Foreign Application Priority Data
May 2, 2018 (CN) 201810411497.4

(51) Int. Cl. G06N 20/00; G06K 9/62; G06F 17/18; G06Q 50/12

(52) U.S. Cl. CPC G06N 20/00; G06K 9/6201; G06Q 50/12; G06K 9/6268; G06F 17/18; G06K 9/6256

(57) ABSTRACT

A model training method and apparatus, a service recommendation method and apparatus, and an electronic device. In an example of the model training method, the method includes: obtaining a sample data set, the sample data set including first-type sample data and second-type sample data; obtaining a first weight corresponding to the first-type sample data and a second weight corresponding to the second-type sample data; performing a weighting operation according to the first weight, the second weight, a loss function corresponding to the first-type sample data, and a loss function corresponding to the second-type sample data, to obtain an overall loss function; and training a machine learning model by using the sample data set based on the overall loss function.

### RELATED APPLICATION

This application for patent claims priority to Chinese Patent Application No. 201810411497.4, filed on May 2, 2018 and entitled “MODEL TRAINING METHOD AND APPARATUS, SERVICE RECOMMENDATION METHOD AND APPARATUS, AND ELECTRONIC DEVICE”, which is incorporated herein by reference in its entirety.

### TECHNICAL FIELD

Embodiments of the present disclosure relate to the field of artificial intelligence technologies, and in particular, to a model training method and apparatus, a service recommendation method and apparatus, and an electronic device.

### BACKGROUND

Machine learning (ML) is the core of artificial intelligence, is applied to every field of artificial intelligence, and is the fundamental way to make computers intelligent. Generally, when a machine learning model is trained, training set samples need to be physically consistent with a prediction set. For example, the training set samples and the prediction set are for the same type of users, to ensure that the trained machine learning model is relatively precise during prediction on the prediction set. However, in some service scenarios, there are a relatively small quantity of training set samples physically consistent with the prediction set. Due to the small quantity of training set samples, parameters of the machine learning model are not fully optimized, causing a decrease in subsequent prediction accuracy.

### SUMMARY

An embodiment of the present disclosure provides a new model training method, including: obtaining a sample data set, the sample data set including first-type sample data and second-type sample data; obtaining a first weight corresponding to the first-type sample data and a second weight corresponding to the second-type sample data; performing a weighting operation according to the first weight, the second weight, a loss function corresponding to the first-type sample data, and a loss function corresponding to the second-type sample data, to obtain an overall loss function; and training a machine learning model by using the sample data set based on the overall loss function.

Optionally, the obtaining a first weight corresponding to the first-type sample data and a second weight corresponding to the second-type sample data includes: determining a first ratio and a second ratio, the first ratio being a probability that a behavior of the first-type sample data is a specified behavior, and the second ratio being a probability that a behavior of the second-type sample data is a specified behavior; and using the first ratio as the first weight, and using the second ratio as the second weight.

Optionally, the obtaining a first weight corresponding to the first-type sample data and a second weight corresponding to the second-type sample data includes: determining classification information of the first-type sample data and classification information of the second-type sample data; and matching the classification information in a preset mapping relationship between classification information and weights, to obtain the first weight corresponding to the first-type sample data and the second weight corresponding to the second-type sample data.

Optionally, the sample data set is a user data set for a hotel and tourism service, the first-type sample data includes user data of a first-level user and a feature label of the user data, the second-type sample data includes user data of a second-level user and a feature label of the user data, the user data includes attribute data and behavior data, the level of the first-level user is higher than the level of the second-level user, and the feature label is used for indicating a correspondence between the user data and a purchase behavior.

An embodiment of the present disclosure further provides a service recommendation method, including: training a target machine learning model by using the model training method according to any one of the foregoing aspects; obtaining a candidate user list, the candidate user list including user data of a plurality of candidate users; inputting the user data of each candidate user into the trained target machine learning model, to obtain a predicted value corresponding to the user data of each candidate user; and using the candidate user corresponding to the user data as a target user when it is detected that the predicted value corresponding to the user data is greater than a first preset threshold, and recommending a target service to the target user.

An embodiment of the present disclosure further provides a model training apparatus, including: a sample data set obtaining module, configured to obtain a sample data set, the sample data set including first-type sample data and second-type sample data; a weight obtaining module, configured to obtain a first weight corresponding to the first-type sample data and a second weight corresponding to the second-type sample data; an overall loss function determining module, configured to perform a weighting operation according to the first weight, the second weight, a loss function corresponding to the first-type sample data, and a loss function corresponding to the second-type sample data, to obtain an overall loss function; and a model training module, configured to train a machine learning model by using the sample data set based on the overall loss function.

Optionally, the weight obtaining module includes: a ratio determining submodule, configured to determine a first ratio and a second ratio, the first ratio being a probability that a behavior of the first-type sample data is a specified behavior, and the second ratio being a probability that a behavior of the second-type sample data is a specified behavior; and a weight using submodule, configured to use the first ratio as the first weight, and use the second ratio as the second weight.

Optionally, the weight obtaining module includes: a classification information determining submodule, configured to determine classification information of the first-type sample data and classification information of the second-type sample data; and a weight matching submodule, configured to match the classification information in a preset mapping relationship between classification information and weights, to obtain the first weight corresponding to the first-type sample data and the second weight corresponding to the second-type sample data.

Optionally, the sample data set is a user data set for a hotel and tourism service, the first-type sample data includes user data of a first-level user and a feature label of the user data, the second-type sample data includes user data of a second-level user and a feature label of the user data, the user data includes attribute data and behavior data, the level of the first-level user is higher than the level of the second-level user, and the feature label is used for indicating a correspondence between the user data and a purchase behavior.

An embodiment of the present disclosure further provides a service recommendation apparatus, including: a model training module, configured to train a target machine learning model by using the model training method according to any one of the foregoing aspects; a candidate user list obtaining module, configured to obtain a candidate user list, the candidate user list including user data of a plurality of candidate users; a predicted value calculation module, configured to input the user data of each candidate user into the trained target machine learning model, to obtain a predicted value corresponding to the user data of the each candidate user; and a service recommendation module, configured to use the candidate user corresponding to the user data as a target user when it is detected that the predicted value corresponding to the user data is greater than a first preset threshold, and recommend a target service to the target user.

An embodiment of the present disclosure further provides an electronic device, including a memory, a processor, and a computer program stored in the memory and capable of being run on the processor, where the processor implements the foregoing method when executing the program.

An embodiment of the present disclosure further provides a non-transitory computer-readable storage medium, storing a computer program, where steps of the foregoing method are implemented when the program is executed by a processor.

The embodiments of the present disclosure include the following advantages: In the embodiments of the present disclosure, the sample data set is obtained, the sample data set including the first-type sample data and the second-type sample data; the first weight corresponding to the first-type sample data and the second weight corresponding to the second-type sample data may be obtained; then the weighting operation may be performed according to the first weight, the second weight, the loss function corresponding to the first-type sample data, and the loss function corresponding to the second-type sample data, to obtain the overall loss function; and the machine learning model is trained by using the sample data set based on the overall loss function. Model training is performed by using a plurality of types of sample data, so that the second-type sample data is used as a supplement to the first-type sample data when the amount of the first-type sample data is relatively small, thereby improving the model training effect.

### BRIEF DESCRIPTION OF THE DRAWINGS

To describe the technical solutions in the embodiments of the present disclosure more clearly, the following briefly describes the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a flowchart of steps of a model training method according to an embodiment of the present disclosure;

FIG. 2 is a flowchart of steps of a model training method according to another embodiment of the present disclosure;

FIG. 3 is a schematic diagram of a cost function according to an embodiment of the present disclosure;

FIG. 4 is a flowchart of steps of a service recommendation method according to an embodiment of the present disclosure;

FIG. 5 is a structural block diagram of a model training apparatus according to an embodiment of the present disclosure; and

FIG. 6 is a structural block diagram of a service recommendation apparatus according to an embodiment of the present disclosure;

FIG. 7 Schematically shows a block diagram of a computing processing device for implementing a method according to the disclosure;

FIG. 8 schematically shows a storage unit for holding or carrying program codes for implementing a method according to the disclosure.

### DETAILED DESCRIPTION OF THE EMBODIMENTS

To make the objectives, features, and advantages of the present disclosure clearer and more comprehensible, the present disclosure is further described in detail below with reference to the accompanying drawings and specific implementations. Apparently, the described embodiments are some embodiments rather than all the embodiments of the present disclosure. All other embodiments obtained by a person of ordinary skill in the art based on the embodiments of the present disclosure without creative efforts shall fall within the protection scope of the present disclosure.

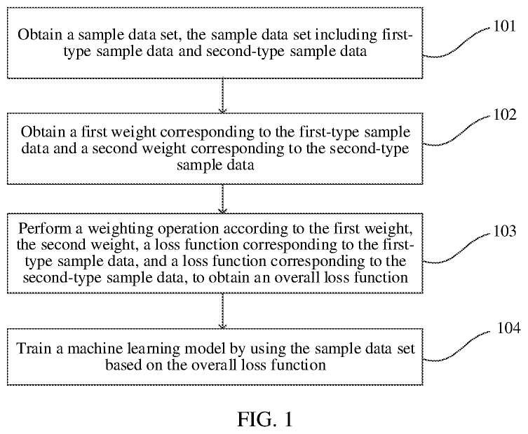

FIG. 1 is a flowchart of steps of a model training method according to an embodiment of the present disclosure. The method may specifically include the following steps:

Step 101: Obtain a sample data set, the sample data set including first-type sample data and second-type sample data.

For example, the sample data set may be a user data set for a hotel and tourism service, the first-type sample data may include user data of a first-level user and a feature label of the user data, the second-type sample data may include user data of a second-level user and a feature label of the user data, and the level of the first-level user is higher than the level of the second-level user. The feature label may be used for indicating a correspondence between corresponding user data and a purchase behavior. For example, feature labels corresponding to some user data indicate that there is a purchase behavior, and feature labels corresponding to some user data indicate that there is no purchase behavior.

In an example, the user data may include attribute data and behavior data. For example, the attribute data may include a user label, a consumption level, and the like of a sample user, and the behavior data may be purchase behavior data, browsing behavior data, and the like of a sample user.

Each machine learning model has a corresponding prediction target, that is, a prediction set. In this embodiment of the present disclosure, not only the first-type sample data relatively strongly correlated to the prediction target is obtained, but also the second-type sample data relatively weakly correlated to the prediction target is obtained. The introduction of more sample data correlated to the prediction target improves the generalization capability of the model.

Actually, the prediction target may be user data for a to-be-predicted user, and the first-type sample data may be sample data physically consistent with the prediction target. For example, the first-type sample data and the prediction target are both the user data of the first-level user. The second-type sample data is not physically consistent with the prediction target, but is correlated to some data of the prediction target. For example, the prediction target is the user data of the first-level user, and the second-type sample data is the user data of the second-level user. However, the second-level user is a second-level user having a specified behavior. For example, in the scenario of a hotel and tourism service, the specified behavior may be a purchase behavior.

For example, in a hotel service, when a quantity of purchase behaviors of a user for a high-star hotel service exceeds a preset quantity, the user is a high-star user; otherwise, the user is a low-star user. When the to-be-predicted user of the prediction target is a high-star user, the first-level user may be a high-star user, and the second-level user may be a low-star user having a purchase behavior for the high-star hotel service.

In an example, the sample data in the sample data set may alternatively be classified into positive sample data and negative sample data, so that in the model training process, the positive sample data and the negative sample data can be differently trained. For example, the positive sample data set may be a user data set having a purchase behavior for a high-star hotel service, and the negative sample data set may be a user data set having a browsing behavior rather than a purchase behavior for the high-star hotel service.

Step 102: Obtain a first weight corresponding to the first-type sample data and a second weight corresponding to the second-type sample data.

After the sample data set is obtained, the first weight corresponding to the first-type sample data and the second weight corresponding to the second-type sample data may be obtained.

In an implementation, the first weight may be directly set to be greater than the second weight, so that in the model training process, different sample data is differently treated, and attention is paid to the first-type sample data with a larger weight.

In another implementation, a probability that a user corresponding to the sample data performs a specified behavior may be determined by analyzing the sample data, and then the weight corresponding to each type of sample data may be determined according to the probability. Correspondingly, step 102 may include:

Determine a first ratio and a second ratio.

The first ratio may be a probability that a behavior of the first-type sample data is a specified behavior, and the second ratio may be a probability that a behavior of the second-type sample data is a specified behavior. For each piece of first-type sample data, the behavior of the first-type sample data may be determined, and then the probability that the specified behavior is the behavior of the first-type sample data may be obtained by collecting statistics as the first ratio. For each piece of second-type sample data, the behavior of the second-type sample data may be determined, and then the probability that the specified behavior is the behavior of the second-type sample data may be obtained by collecting statistics as the second ratio.

For example, the second-type sample data includes 10 pieces of purchase behavior data for hotel services, and there are one piece of purchase behavior data for a high-star hotel service and nine pieces of purchase behavior data for low-star hotels. Therefore, it may be determined that the ratio of the purchase behavior data for the high-star hotel service to all the purchase behavior data for hotel services is 10%, that is, the second ratio is 10%.

Use the first ratio as the first weight, and use the second ratio as the second weight.

After the ratios are determined, the first ratio is used as the first weight corresponding to the first-type sample data, and the second ratio is used as the second weight corresponding to the second-type sample data.

Alternatively, a weight corresponding to the first ratio may be obtained from a preset mapping relationship between ratios and weights, and used as the first weight corresponding to the first-type sample data, and a weight corresponding to the second ratio may be obtained as the second weight corresponding to the second-type sample data.

In another implementation, the category of the sample data may alternatively be determined by analyzing the sample data, and then the weight corresponding to the sample data may be determined according to the category. Correspondingly, step 102 may include:

Determine classification information of the first-type sample data and classification information of the second-type sample data.

The classification information may include a user type corresponding to the sample data. For example, a user type corresponding to the first-type sample data is the first-level user, and a user type corresponding to the second-type sample data is the second-level user.

In a specific implementation, the sample data may include the classification information. Therefore, for each piece of sample data, the classification information may be obtained from a specified field.

Match the classification information in a preset mapping relationship between classification information and weights, to obtain the first weight corresponding to the first-type sample data and the second weight corresponding to the second-type sample data.

After the classification information is obtained, the classification information may be matched in the preset mapping relationship between classification information and weights, then a weight corresponding to the classification information corresponding to the first-type sample data may be determined as the first weight corresponding to the first-type sample data, and a weight corresponding to the classification information corresponding to the second-type sample data may be determined as the second weight corresponding to the second-type sample data.

Step 103: Perform a weighting operation according to the first weight, the second weight, a loss function corresponding to the first-type sample data, and a loss function corresponding to the second-type sample data, to obtain an overall loss function.

In this embodiment of the present disclosure, loss functions may be set for the first-type sample data and the second-type sample data respectively, to respectively calculate a prediction loss of the first-type sample data and a prediction loss of the second-type sample data.

The prediction loss is a difference between a predicted value and a pre-collected true value when prediction is performed on one type of sample data.

After the weights are obtained, a weighting operation may be performed on the loss function corresponding to the first-type sample data by using the first weight, and a weighting operation may be performed on the loss function corresponding to the second-type sample data by using the second weight, and then the weighted loss functions may be organized as the overall loss function, to calculate an overall prediction loss corresponding to the sample data set.

The loss function may be represented by the following formula:

L=abs(wᵢ [symbol] −wᵢyⁱ) (1),

L is a prediction loss corresponding to the first-type sample data or the second-type sample data, [symbol] is a predicted value corresponding to an ith piece of first-type sample data or an ith piece of second-type sample data, yⁱ is a pre-collected true value corresponding to the ith piece of first-type sample data or the ith piece of second-type sample data, and wᵢ is a first weight corresponding to the ith first-type sample data or a second weight corresponding to the ith second-type sample data. For the same type of sample data, the value of wᵢ of each piece of data is the same, and is equal to a weight corresponding to the type of data. abs indicates an absolute value operation.

The overall loss function may be represented by the following formula (2):

$$J = \frac{1}{n} {\sum }_{i = 1}^{n} abs ( {W}_{1} - {W}_{1} {y}^{i} ) + \frac{1}{m} {\sum }_{j = 1}^{m} abs ( {W}_{2} - {W}_{2} {y}^{j} ) , \qquad ( 2 )$$

J is an overall prediction loss, n is a quantity of pieces of data of the first-type sample data, m is a quantity of pieces of data of the second-type sample data, W₁ is the first weight, W₂ is the second weight, and Σ indicates a summation operation.

In an example, the overall loss function may alternatively be represented by the following formula (3):

J=W₁J₁+W₂J₂ (3),

J₁ is a prediction loss corresponding to the first-type sample data, W₁ is the first weight, J₂ is a prediction loss corresponding to the second-type sample data, and W₂ is the second weight.

J₁ and J₂ may be calculated by using the following formula (4):

$$J = \frac{1}{n} {\sum }_{i = 1}^{n} - ( {y}^{i} lg ( + ( 1 - {y}^{i} ) lg ( 1 - ) \qquad ( 4 )$$

Step 104: Train a machine learning model by using the sample data set based on the overall loss function.

After the overall loss function is obtained, the overall prediction loss of the sample data may be calculated by using the overall loss function. Then model training is performed on the sample data according to the overall prediction loss. For example, model training may be iteratively performed by using a gradient boosting decision tree (GBDT) algorithm. The target of iteration may be decreasing the overall loss function of the sample data to as much as possible, to finally find an optimal parameter of the model.

In any one of the foregoing embodiments of the present disclosure, the sample data set is obtained, the sample data set including the first-type sample data and the second-type sample data; the first weight corresponding to the first-type sample data and the second weight corresponding to the second-type sample data may be obtained; then the weighting operation may be sequentially performed on the loss function corresponding to the first-type sample data and the loss function corresponding to the second-type sample data by using the first weight and the second weight, to obtain the overall loss function; and model training is performed by using the sample data set based on the overall loss function. Model training is performed by using a plurality of types of sample data, so that the second-type sample data is used as a supplement to the first-type sample data when the amount of the first-type sample data is relatively small, thereby improving the model training effect.

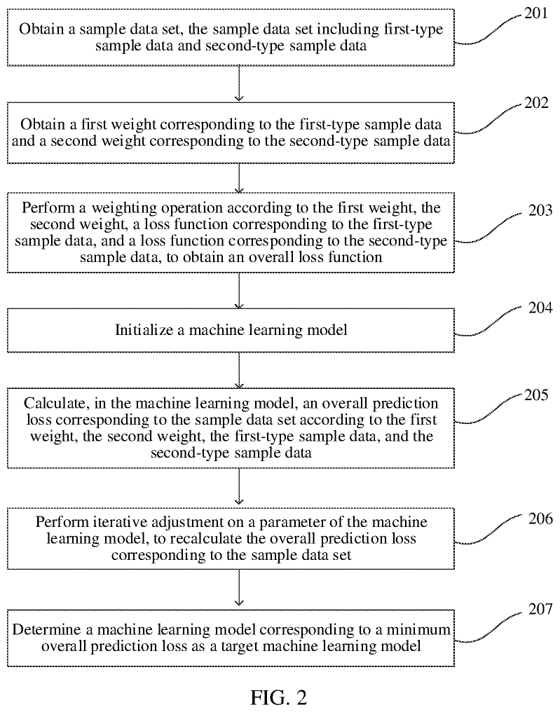

FIG. 2 is a flowchart of steps of another model training method according to an embodiment of the present disclosure. The method may specifically include the following steps:

Step 201: Obtain a sample data set, the sample data set including first-type sample data and second-type sample data.

Each machine learning model has a corresponding prediction target, that is, a prediction set. In this embodiment of the present disclosure, not only the first-type sample data strongly correlated to the prediction target may be obtained, but also the second-type sample data weakly correlated to the prediction target may be obtained. The introduction of more sample data correlated to the prediction target improves the generalization capability of the model.

Step 202: Obtain a first weight corresponding to the first-type sample data and a second weight corresponding to the second-type sample data.

After the sample data set is obtained, the first weight corresponding to the first-type sample data and the second weight corresponding to the second-type sample data may be obtained.

Step 203: Perform a weighting operation according to the first weight, the second weight, a first loss function corresponding to the first-type sample data, and a second loss function corresponding to the second-type sample data, to obtain an overall loss function.

After the weights are obtained, the overall loss function may be determined. A weighting operation may be performed on the loss function corresponding to the first-type sample data by using the first weight, and a weighting operation may be performed on the loss function corresponding to the second-type sample data by using the second weight, and then the weighted loss functions may be organized as the overall loss function.

Step 204: Initialize a machine learning model.

In actual application, the machine learning model may have a plurality of model parameters. The model parameters of the machine learning model may be initialized before model training starts.

Step 205: Calculate, in the machine learning model, an overall prediction loss corresponding to the sample data set by using the overall loss function according to the first-type sample data and the second-type sample data.

After the initialization, the sample data set may be inputted into the machine learning model, and the machine learning model may perform prediction on the sample data set, to obtain a predicted value corresponding to each piece of sample data. The predicted value and a true value of each piece of sample data in the sample data set may be separately calculated by using the overall loss function according to the pre-collected true value of each piece of sample data, to obtain the overall prediction loss corresponding to the sample data set.

In an embodiment of the present disclosure, the overall loss function may calculate the overall prediction loss corresponding to the sample data set in the following manner:

Calculate a first prediction loss of the predicted value corresponding to the first-type sample data, and weight the first prediction loss by using the first weight, to obtain a first weighted prediction loss.

For each piece of first-type sample data, the true value corresponding to each piece of first-type sample data may be collected in advance, and then an absolute value of a difference between the predicted value and the true value is calculated, to obtain the first prediction loss. Then, the first prediction loss may be weighted by using the first weight, to obtain the first weighted prediction loss.

Calculate a second prediction loss of the predicted value corresponding to the second-type sample data, and weight the second prediction loss by using the second weight, to obtain a second weighted prediction loss.

For each piece of second-type sample data, the true value corresponding to each piece of second-type sample data may be collected in advance, and then an absolute value of a difference between the predicted value and the true value is calculated, to obtain the second prediction loss. Then, the second prediction loss may be weighted by using the second weight, to obtain the second weighted prediction loss.

Perform mean calculation on the first weighted prediction loss and the second weighted prediction loss, to obtain the overall prediction loss of the predicted value corresponding to the sample data.

After the weighted prediction loss is obtained, mean calculation may be performed on the weighted prediction loss of each piece of sample data, to obtain the overall prediction loss corresponding to the sample data set.

Step 206: Perform iterative adjustment on a parameter of the machine learning model, to recalculate the overall prediction loss corresponding to the sample data set.

After the overall prediction loss is obtained, the model parameter may be iterated to obtain an iterated machine learning model, and then the overall prediction loss is recalculated by using the iterated model.

Further, in actual application, each piece of sample data may have one or more sample features. The model parameter in the machine learning model may be a sample weight set for each sample feature. Different overall prediction losses are obtained by iterating the sample weight.

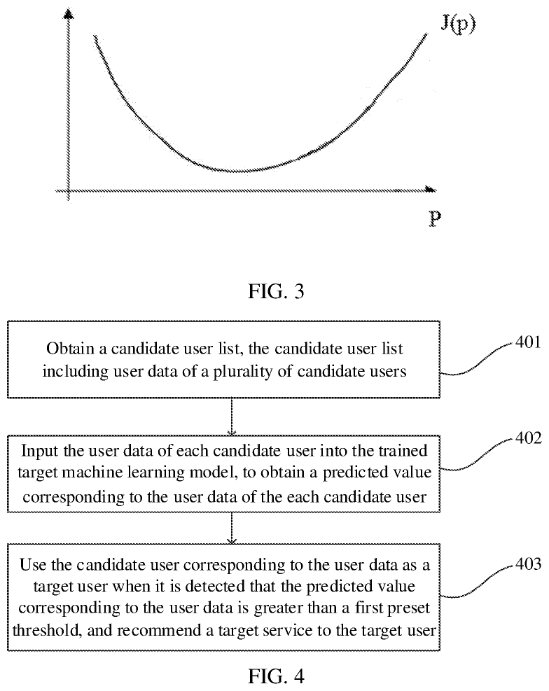

With the iteration of the machine learning model, a plurality of overall prediction losses may be obtained through calculation by using the overall loss function. As shown in FIG. 3, p indicates a p^{th} group of model parameters, and J(p) indicates an overall prediction loss. The overall loss function is converged along the direction where the function value of the overall loss function drops the fastest, to obtain model parameters that minimize the overall loss function, and then a target machine learning model is established.

Step 207: Determine a machine learning model corresponding to a minimum overall prediction loss as a target machine learning model.

In any one of the foregoing embodiments of the present disclosure, the sample data set is obtained first, the sample data set including the first-type sample data and the second-type sample data; and the first weight corresponding to the first-type sample data and the second weight corresponding to the second-type sample data may be obtained. Then, the weighting operation may be performed according to the first weight, the second weight, the loss function corresponding to the first-type sample data, and the loss function corresponding to the second-type sample data, to obtain the overall loss function, and model training is performed by using the sample data set based on the overall loss function. Model training is performed by using a plurality of types of sample data, so that the second-type sample data is used as a supplement to the first-type sample data when the amount of the first-type sample data is relatively small, thereby improving the model training effect.

In addition, in the model iteration process, the overall prediction loss corresponding to the sample data set is calculated by using the overall loss function, to determine the target machine learning model corresponding to the minimum overall prediction loss, thereby ensuring the model prediction accuracy and reducing the model prediction loss.

FIG. 4 is a flowchart of steps of a service recommendation method according to an embodiment of the present disclosure. The method may specifically include the following steps:

Step 401: Obtain a candidate user list, the candidate user list including user data of a plurality of candidate users.

The candidate user may be a user whose user level is higher than a second preset threshold in a hotel and tourism service. For example, the candidate user may be a first-level user, that is, a high-star user.

When a target service needs to be recommended, a user type corresponding to the target service may be determined, then a plurality of candidate users meeting the user type are screened out from backend data, and user data of the plurality of candidate users is obtained, to obtain a candidate user list.

For example, when a to-be-recommended target service is a hotel and tourism service for a high-star user, all high-star users may be used as the candidate users, and user data of the high-star users is obtained.

Step 402: Input the user data of each candidate user into the trained target machine learning model, to obtain a predicted value corresponding to the user data of the each candidate user.

After the candidate user list is obtained, the user data of the each candidate user may be inputted into the target machine learning model, and the target machine learning model performs prediction on the user data of the each candidate user, to obtain the predicted value corresponding to the user data of the each candidate user.

The training a target machine learning model by using the model training method according to any one of the foregoing embodiments mainly includes the following steps: obtaining a sample data set, the sample data set including first-type sample data and second-type sample data; obtaining a first weight corresponding to the first-type sample data and a second weight corresponding to the second-type sample data; performing a weighting operation according to the first weight, the second weight, a loss function corresponding to the first-type sample data, and a loss function corresponding to the second-type sample data, to obtain an overall loss function; and training a machine learning model by using the sample data set based on the overall loss function, to obtain a target machine learning model.

For a process of establishing the target machine learning model, reference may be made to the descriptions of the model training method in the foregoing embodiments, and details are not described herein again.

Step 403: Use the candidate user corresponding to the user data as a target user when it is detected that the predicted value corresponding to the user data is greater than a first preset threshold, and recommend an associated target service to the target user.

The target service may be a hotel and tourism service associated with the candidate user, for example, may be a hotel and tourism service for a first-level user (a high-star user).

After the predicted value is obtained, whether the predicted value corresponding to the user data is greater than the first preset threshold may be determined. If the predicted value is greater than the first preset threshold, the candidate user corresponding to the user data is used as the target user. After the target user is determined, the associated target service may be recommended to the target user, for example, a subsidized coupon may be distributed to the target user.

In this embodiment of the present disclosure, the candidate user list is obtained, and the candidate user list may include user data of a plurality of candidate users; the user data of the each candidate user is inputted into the trained target machine learning model, to obtain the predicted value corresponding to the user data of the each candidate user; and when it is detected that the predicted value corresponding to the user data is greater than the first preset threshold, the candidate user corresponding to the user data is used as the target user, and then the associated target service is recommended to the target user. The target machine learning model is used for prediction, and service recommendation is performed based on the prediction result, thereby improving the success rate of the service recommendation.

It should be noted that, the method embodiments are represented as a series of actions for the purpose of brief description. However, it is to be learned by a person skilled in the art that because some steps may be performed in other orders or simultaneously according to the embodiments of the present disclosure, the embodiments of the present disclosure are not limited to the described order of the actions. In addition, a person skilled in the art also needs to know that the embodiments described in this specification are all exemplary embodiments; and therefore, the actions involved are not necessarily mandatory in the embodiments of the present disclosure.

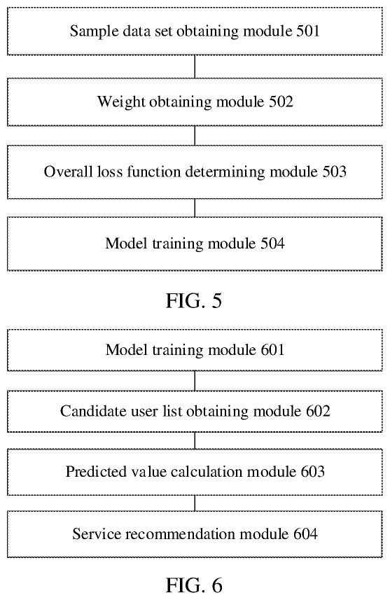

FIG. 5 is a structural block diagram of a model training apparatus according to an embodiment of the present disclosure. The apparatus may specifically include the following modules:

a sample data set obtaining module 501, configured to obtain a sample data set, the sample data set including first-type sample data and second-type sample data;

a weight obtaining module 502, configured to obtain a first weight corresponding to the first-type sample data and a second weight corresponding to the second-type sample data;

an overall loss function determining module 503, configured to perform a weighting operation according to the first weight, the second weight, a loss function corresponding to the first-type sample data, and a loss function corresponding to the second-type sample data, to obtain an overall loss function; and

a model training module 504, configured to train a machine learning model by using the sample data set based on the overall loss function.

In an embodiment of the present disclosure, the weight obtaining module 502 includes: a ratio determining submodule, configured to determine a first ratio and a second ratio, the first ratio being a probability that a behavior of the first-type sample data is a specified behavior, and the second ratio being a probability that a behavior of the second-type sample data is a specified behavior; and a weight using submodule, configured to use the first ratio as the first weight, and use the second ratio as the second weight.

In an embodiment of the present disclosure, the weight obtaining module 502 includes: a classification information determining submodule, configured to determine classification information of the first-type sample data and classification information of the second-type sample data; and a weight matching submodule, configured to match the classification information in a preset mapping relationship between classification information and weights, to obtain the first weight corresponding to the first-type sample data and the second weight corresponding to the second-type sample data.

In an embodiment of the present disclosure, the sample data set is a user data set for a hotel and tourism service, the first-type sample data includes user data of a first-level user and a feature label of the user data, the second-type sample data includes user data of a second-level user and a feature label of the user data, the level of the first-level user is higher than the level of the second-level user, and the feature label is used for indicating a correspondence between the user data and a purchase behavior.

In an embodiment of the present disclosure, the user data includes attribute data and behavior data.

In any one of the foregoing embodiments of the present disclosure, the sample data set is obtained, the sample data set including the first-type sample data and the second-type sample data; the first weight corresponding to the first-type sample data and the second weight corresponding to the second-type sample data may be obtained; then the weighting operation may be performed according to the first weight, the second weight, the loss function corresponding to the first-type sample data, and the loss function corresponding to the second-type sample data, to obtain the overall loss function; and the machine learning model is trained by using the sample data set based on the overall loss function. Model training is performed by using a plurality of types of sample data, so that the second-type sample data is used as a supplement to the first-type sample data when the amount of the first-type sample data is relatively small, thereby improving the model training effect.

FIG. 6 is a structural block diagram of a service recommendation apparatus according to an embodiment of the present disclosure. The apparatus may specifically include the following modules:

a model training module 601, configured to train a target machine learning model by using the model training method according to any one of the foregoing method embodiments;

a candidate user list obtaining module 602, configured to obtain a candidate user list, the candidate user list including user data of a plurality of candidate users;

a predicted value calculation module 603, configured to input the user data of each candidate user into the trained target machine learning model, to obtain a predicted value corresponding to the user data of the each candidate user; and

a service recommendation module 604, configured to use the candidate user corresponding to the user data as a target user when it is detected that the predicted value corresponding to the user data is greater than a first preset threshold, and recommend a target service to the target user.

In an embodiment of the present disclosure, the target service is a hotel and tourism service associated with the candidate user, and the candidate user is a user whose user level is higher than a second preset threshold in the hotel and tourism service.

In this embodiment of the present disclosure, the candidate user list is obtained; the user data of the each candidate user is inputted into the trained target machine learning model, to obtain the predicted value corresponding to the user data of the each candidate user; and when it is detected that the predicted value corresponding to the user data is greater than the first preset threshold, the candidate user corresponding to the user data is used as the target user, and then the associated target service is recommended to the target user. The target machine learning model is used for prediction, and service recommendation is performed based on the prediction result, thereby improving the success rate of the service recommendation.

The apparatuses in the embodiments of the present disclosure may be configured to correspondingly perform the methods provided in the foregoing embodiments. For related terms and descriptions, reference may be made to the descriptions about the methods, and details are not described herein again.

An embodiment of the present disclosure further discloses an electronic device, including a memory, a processor, and a computer program stored in the memory and capable of being run on the processor, where the processor implements the foregoing method when executing the program.

An embodiment of the present disclosure further discloses a non-transitory computer-readable storage medium, storing a computer program, where steps of the foregoing method are implemented when the program is executed by a processor.

The embodiments in this specification are all described in a progressive manner. Description of each of the embodiments focuses on differences from other embodiments, and reference may be made to each other for the same or similar parts among respective embodiments.

A person skilled in the art needs to understand that the embodiments of the present disclosure may be provided as a method, an apparatus, or a computer program product. Therefore, the embodiments of the present disclosure may use a form of hardware-only embodiments, software-only embodiments, or embodiments with a combination of software and hardware. In addition, the embodiments of the present disclosure may use a form of a computer program product implemented on one or more computer-usable storage media (including but not limited to a disk memory, a CD-ROM, an optical memory, and the like) that include computer-usable program code.

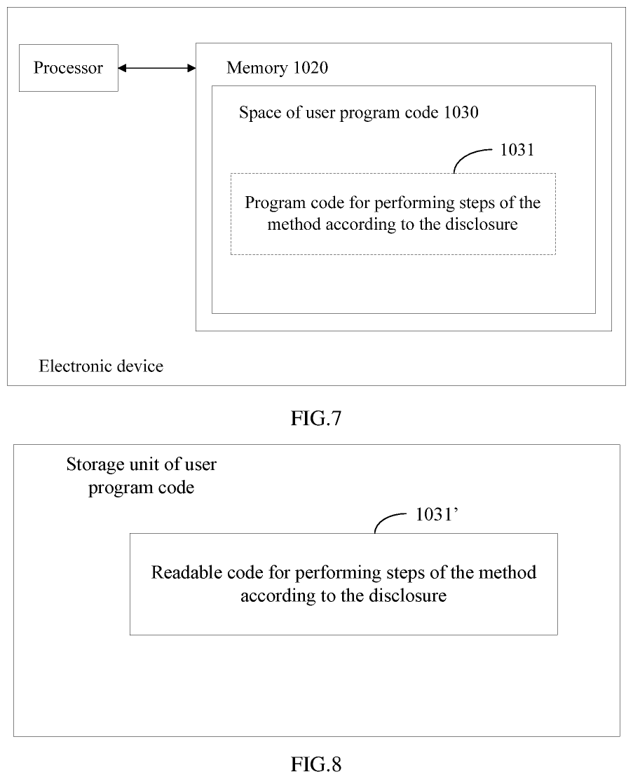

For example, FIG. 7 shows an electronic device in which the method according to the disclosure may be implemented. The electronic device conventionally includes a processor 1010 and a computer program product or computer-readable medium in the form of a memory 1020. The memory 1020 may be an electronic memory such as a flash memory, an EEPROM (Electrically Erasable Programmable Read Only Memory), an EPROM, a hard disk, or a ROM. The memory 1020 has a storage space 1030 for program codes 1031 for performing any of the method steps in the above methods. For example, the storage space 1030 for program codes may include respective program codes 1031 for implementing the various steps in the above methods, respectively. The program codes may be read from or written to one or more computer program products. These computer program products include a program code carrier such as a hard disk, a compact disk (CD), a memory card or a floppy disk. Such a computer program product is typically a portable or fixed storage unit as described with reference to FIG. 8. The storage unit may have storage segments, storage space, etc., arranged similarly to the memory 1020 in the computing processing device of FIG. 7. The program codes may be compressed, for example, in a suitable form. Typically, the storage unit includes computer-readable codes 1031′, i.e., codes readable by a processor, such as 1010, for example, which, when executed by an electronic device, causes the electronic device to perform the various steps of the methods described above.

The embodiments of the present disclosure are described with reference to the flowcharts and/or block diagrams of the method, the terminal device (system), and the computer program product according to the embodiments of the present disclosure. It is to be understood that computer program instructions can implement each process and/or block in the flowcharts and/or block diagrams and a combination of processes and/or blocks in the flowcharts and/or block diagrams. These computer program instructions may be provided for a general-purpose computer, a dedicated computer, an embedded processor, or a processor of any other programmable data processing terminal device to generate a machine, so that the instructions executed by a computer or a processor of any other programmable data processing terminal device generate an apparatus for implementing functions specified in one or more processes in the flowcharts and/or in one or more blocks in the block diagrams.

These computer program instructions may also be stored in a computer-readable memory that can guide a computer or another programmable data processing terminal device to work in a specific manner, so that the instructions stored in the computer-readable memory generate a product including an instruction apparatus, where the instruction apparatus implements functions specified in one or more processes in the flowcharts and/or in one or more blocks in the block diagrams.

These computer program instructions may also be loaded onto a computer or another programmable data processing terminal device, so that a series of operations and steps are performed on the computer or another programmable terminal device to generate computer-implemented processing. Therefore, the instructions executed on the computer or the another programmable terminal device provide steps for implementing functions specified in one or more processes in the flowcharts and/or in one or more blocks in the block diagrams.

Although exemplary embodiments of the present disclosure have been described, a person skilled in the art may make changes and modifications to these embodiments once learning the basic inventive concept. Therefore, the appended claims are intended to cover the exemplary embodiments and all changes and modifications falling within the scope of the embodiments of the present disclosure.

At last, it should be noted that, in this specification, relational terms such as first and second are used only to distinguish one entity or operation from another, and do not necessarily require or imply any actual relationship or sequence between these entities or operations. Moreover, the terms “include”, “comprise”, and any variants thereof are intended to cover a non-exclusive inclusion. Therefore, a process, method, object, or terminal device that includes a series of elements not only includes such elements, but also includes other elements not specified expressly, or may include inherent elements of the process, method, object, or terminal device. Unless otherwise specified, an element limited by “include a/an . . . ” does not exclude other same elements existing in the process, method, object, or terminal device that includes the element.

A model training method and apparatus and a service recommendation method and apparatus that are provided in the present disclosure are described above in detail. In this specification, specific examples are used to describe the principle and implementations of the present disclosure, and the descriptions of the embodiments are only intended to help understand the method and the core idea of the present disclosure. Meanwhile, a person of ordinary skill in the art may make modifications to the specific implementations and the application scope based on the idea of the present disclosure. Therefore, the content of this specification shall not be construed as a limitation to the present disclosure.

What is claimed is:

1. A model training method, comprising:
obtaining, by one or more processors, a sample data set, the sample data set comprising first-type sample data and second-type sample data;
obtaining, by one or more processors, a first weight corresponding to the first-type sample data and a second weight corresponding to the second-type sample data;
performing, by one or more processors, a weighting operation according to the first weight, the second weight, a loss function corresponding to the first-type sample data, and a loss function corresponding to the second-type sample data, to obtain an overall loss function; and
training, by one or more processors, a machine learning model by using the sample data set based on the overall loss function.

2. The method according to claim 1, wherein the obtaining a first weight corresponding to the first-type sample data and a second weight corresponding to the second-type sample data comprises:
determining, by one or more processors, a first ratio and a second ratio, the first ratio being a probability that a behavior of the first-type sample data is a specified behavior, and the second ratio being a probability that a behavior of the second-type sample data is a specified behavior; and
using, by one or more processors, the first ratio as the first weight, and using the second ratio as the second weight.

3. The method according to claim 1, wherein the obtaining a first weight corresponding to the first-type sample data and a second weight corresponding to the second-type sample data comprises:
determining, by one or more processors, classification information of the first-type sample data and classification information of the second-type sample data; and
matching, by one or more processors, the classification information in a preset mapping relationship between classification information and weights, to obtain the first weight corresponding to the first-type sample data and the second weight corresponding to the second-type sample data.

4. The method according to claim 3, wherein
the sample data set is a user data set for a hotel and tourism service;
the first-type sample data comprises user data of a first-level user and a feature label of the user data;
the second-type sample data comprises user data of a second-level user and a feature label of the user data, the level of the first-level user is higher than the level of the second-level user; and
the feature label is used for indicating a correspondence between the user data and a purchase behavior.

5. The method according to claim 4, wherein the user data comprises attribute data and behavior data.

6. A service recommendation method, comprising:
training, by one or more processors, a target machine learning model by using the method according to claim 1;
obtaining, by one or more processors, a candidate user list, the candidate user list comprising user data of a plurality of candidate users;
inputting, by one or more processors, the user data of each candidate user into the trained target machine learning model, to obtain a predicted value corresponding to the user data of the each candidate user; and
using, by one or more processors, the candidate user corresponding to the user data as a target user when it is detected that the predicted value corresponding to the user data is greater than a first preset threshold, and recommending a target service to the target user.

7. The method according to claim 6, wherein, the obtaining a first weight corresponding to the first-type sample data and a second weight corresponding to the second-type sample data comprises:
determining, by one or more processors, a first ratio and a second ratio, the first ratio being a probability that a behavior of the first-type sample data is a specified behavior, and the second ratio being a probability that a behavior of the second-type sample data is a specified behavior; and
using, by one or more processors, the first ratio as the first weight, and using the second ratio as the second weight.

8. The method according to claim 6, wherein the obtaining a first weight corresponding to the first-type sample data and a second weight corresponding to the second-type sample data comprises:
determining, by one or more processors, classification information of the first-type sample data and classification information of the second-type sample data; and
matching, by one or more processors, the classification information in a preset mapping relationship between classification information and weights, to obtain the first weight corresponding to the first-type sample data and the second weight corresponding to the second-type sample data.

9. The method according to claim 8, wherein,
the sample data set is a user data set for a hotel and tourism service;
the first-type sample data comprises user data of a first-level user and a feature label of the user data;
the second-type sample data comprises user data of a second-level user and a feature label of the user data, the level of the first-level user is higher than the level of the second-level user; and
the feature label is used for indicating a correspondence between the user data and a purchase behavior.

10. The method according to claim 9, wherein the user data comprises attribute data and behavior data.

11. An electronic device, comprising a memory, a processor, and a computer program stored in the memory and capable of being run on the processor, wherein the processor performs the following operations, comprises:
obtaining a sample data set, the sample data set comprising first-type sample data and second-type sample data;
obtaining a first weight corresponding to the first-type sample data and a second weight corresponding to the second-type sample data;
performing a weighting operation according to the first weight, the second weight, a loss function corresponding to the first-type sample data, and a loss function corresponding to the second-type sample data, to obtain an overall loss function; and
training a machine learning model by using the sample data set based on the overall loss function.

12. The electronic device according to claim 11, wherein the obtaining a first weight corresponding to the first-type sample data and a second weight corresponding to the second-type sample data comprises:
determining a first ratio and a second ratio, the first ratio being a probability that a behavior of the first-type sample data is a specified behavior, and the second ratio being a probability that a behavior of the second-type sample data is a specified behavior; and
using the first ratio as the first weight, and using the second ratio as the second weight.

13. The electronic device according to claim 11, wherein the obtaining a first weight corresponding to the first-type sample data and a second weight corresponding to the second-type sample data comprises:
determining classification information of the first-type sample data and classification information of the second-type sample data; and
matching the classification information in a preset mapping relationship between classification information and weights, to obtain the first weight corresponding to the first-type sample data and the second weight corresponding to the second-type sample data.

14. The electronic device according to claim 13, wherein
the sample data set is a user data set for a hotel and tourism service;
the first-type sample data comprises user data of a first-level user and a feature label of the user data;
the second-type sample data comprises user data of a second-level user and a feature label of the user data, the level of the first-level user is higher than the level of the second-level user; and
the feature label is used for indicating a correspondence between the user data and a purchase behavior.

15. The electronic device according to claim 14, wherein the user data comprises attribute data and behavior data.

16. The electronic device according to claim 11, further comprises:
training, by one or more processors, a target machine learning model;
obtaining, by one or more processors, a candidate user list, the candidate user list comprising user data of a plurality of candidate users;
inputting, by one or more processors, the user data of each candidate user into the trained target machine learning model, to obtain a predicted value corresponding to the user data of the each candidate user; and
using, by one or more processors, the candidate user corresponding to the user data as a target user when it is detected that the predicted value corresponding to the user data is greater than a first preset threshold, and recommending a target service to the target user.

17. A non-transitory computer-readable storage medium, storing a computer program, wherein steps of the method according to claim 1 are implemented when the program is executed by a processor.
